(19) United States
(12) Patent Application Publication
(10) Pub. No.: US 2003/0157922 A1
(43) Pub. Date: Aug. 21, 2003

(54) Emergency location of wireless call originators

(76) Inventors: Akhteruzzaman, Naperville, IL (US); Paul Raymond Sand, Woodridge, IL (US); Richard Grant Sparber, Wheaton, IL (US); Claudis L. Young, Aurora, IL (US)

Correspondence Address: Werner Ulrich, 434 Maple Street, Glen Ellyn, IL, 60137-3826, US

(21) Appl. No.: 10/080,316

(22) Filed: Feb. 21, 2002

(51) Int. Cl. H04Q 7/20

(52) U.S. Cl. 455/404; 455/456

(57) ABSTRACT

The method and apparatus for tracing the progress of a mobile station which has initiated an emergency call. Using the facilities of the Global Positioning System (GPS), the mobile station repeatedly reports its location to the Emergency Bureau, which thereby is able to track the movement of the mobile station. In one preferred embodiment, location measurements are taken more frequently if the mobile station is moving. Advantageously, this arrangement allows the progress of the mobile station originating the emergency call to be followed, thus helping the Police or Ambulance Services provided through the Emergency Bureau to locate the mobile station more accurately.

### TECHNICAL FIELD

This invention relates to the location of originators of wireless calls using systems such as the Global Positioning System.

### PROBLEM

The use of the Global Positioning System for locating automobiles has become widespread as a means of helping drivers to find a destination. More recently, it has been recognized that for a car occupant's making an emergency call, such as a “911” call, it can be especially useful to be able to provide the Emergency Service Bureau with information concerning the present location of the car. People who make emergency calls frequently do not know exactly where they are. It has therefore been proposed that eventually, most cars should be equipped with facilities for providing an Emergency Bureau with their location when they make a “911” call. The problem with this arrangement is that it does not take full advantage of the capabilities of Global Positioning Service.

### SOLUTION

Applicants have studied this problem, and have recognized that while the location of a car that is originating a “911” call is useful if the car is moving, especially if the car is moving rapidly, such information is quickly out-of-date.

This problem is solved, and an advance is made over the teachings of the prior art in accordance with this invention, wherein the location of a car is tracked so that if the car is moving, an up-to-date location and an indication of a path is received at the Emergency Service Bureau (“Point of Presence”).

In accordance with one feature of Applicants' invention, in order to conserve GPS resources, a car is not continuously tracked if it is not moving.

In accordance with another feature of Applicants' invention, a special code “911” call is automatically made if a disabling system is not energized when a car is started. Advantageously, if the car is being stolen, its location is automatically received by the Emergency Service Bureau, and this location is updated to follow the car.

### BRIEF DESCRIPTION OF THE DRAWING(S)

FIG. 1 is a block diagram illustrating the operation of a system for locating automobiles; and

FIG. 2 is a flow diagram illustrating the operation of Applicants' invention.

### DETAILED DESCRIPTION

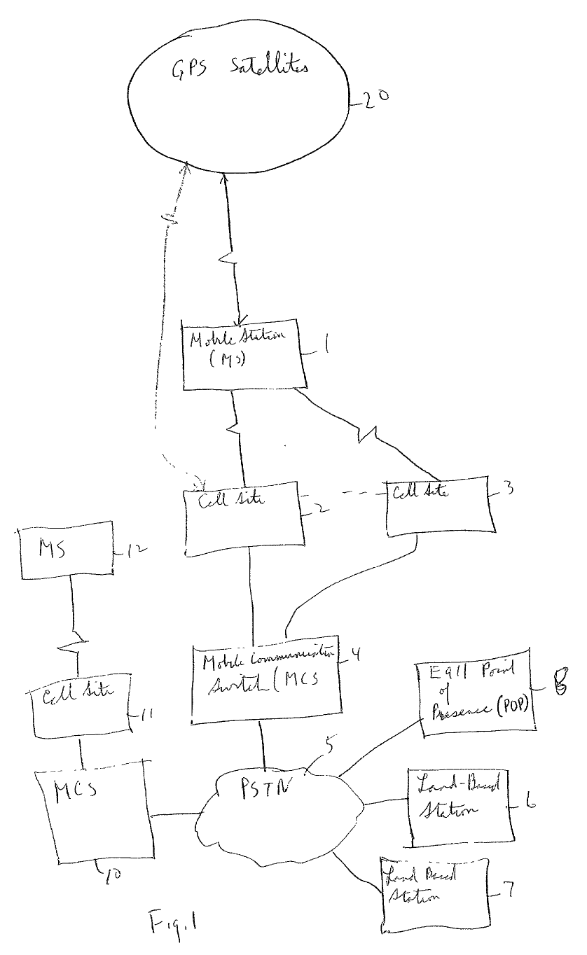

FIG. 1 is a block diagram illustrating the operation of apparatus for locating a mobile station that has dialed a “911” call. Mobile Station (1) is connected by a radio channel to one of several cell sites (2), . . . (3), which are connected to a Mobile Communication Switch (4). This Mobile Communication Switch is connected to the Public Switched Telephone Network (PSTN) for accessing land based Stations (6), . . . (7), or an E 911 Point of Presence (8), an Emergency Bureau. Public switched telephone network (5) is also connected to another Mobile Communications Switch (10) which is connected to other cell sites, such as cell site (11), which in tun are connected to other mobile stations, such as Mobile Station (12). A Mobile Station (1) makes a “911” call. The E 911 Point of Presence (8) sends a signal to the mobile station requesting the mobile station (1) to take a location measurement.

Techniques for taking a location measurement based on the use of Global Positioning Satellites (GPS) (20) are well known and constantly evolving. These techniques include simple GPS measurements and differential GPS measurements. This disclosure simply assumes that any available location measurement technique is used, preferably, the one that achieves the best resolution with the available equipment.

In accordance with Applicants' invention, the mobile station makes repeated measurements of its location so that if the mobile station is moving, it can be tracked at the E 911 Point of Presence.

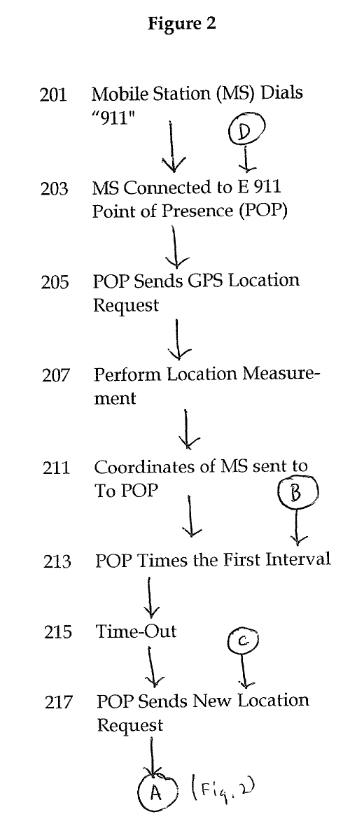

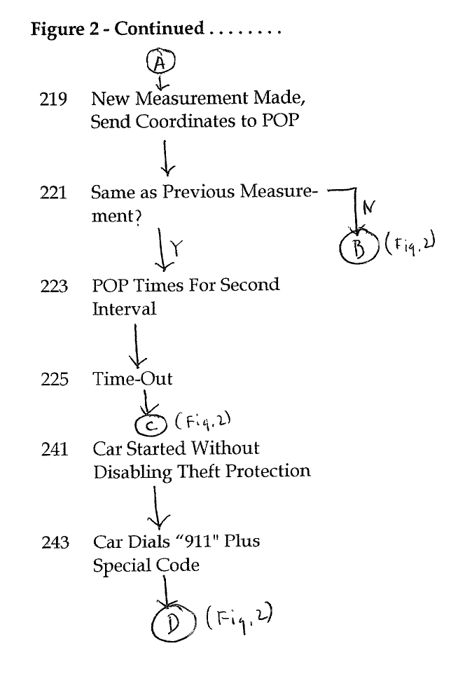

FIG. 2 is a flow diagram illustrating the operation of Applicants' invention, and several features of this invention. The Mobile Station (MS) dials “911”, Action Block (201). The Mobile Station is connected to the E 911 Point of Presence (POP), Action Block (203). The POP sends a GPS location request, Action Block (205). The MS and/or the cell sites, perform a location measurement, Action Block (207). The coordinates of the location of the MS are sent to the POP, Action Block (211). The POP then times for a first interval, Action Block (213). Following a time-out, Action Block (215), the POP sends a new location request. A new measurement is taken, and this new measurement is sent to the POP, Action Block (219). The POP tests whether this location is the same as the previously measured location, Test (221). If not, then Action Block (213) is re-entered so that after another time-out of the first interval, another measurement will be taken. If the present measurement is the same as the previous measurement, then Action Block (223) is entered to time for a second interval longer than the first interval. Following the time-out of this second interval, Action Block (217) is re-entered, and a new location request is sent. Thus, there are two different time intervals, a shorter time interval in case the mobile is moving, and a longer time interval in case the mobile is stopped. If the mobile moves after having been stopped, a shorter time interval is used again. This technique is especially helpful if the location measurement requires the use of cell site resources.

In accordance with one application of Applicants' invention, an automobile is equipped with an instrument which, if not disabled, will, in response to the car being started, Action Block (241), dial “911” plus a special code, Action Block (243). Thereafter, Action Block (203) is entered, and the mobile is effectively traced until the car is apprehended.

The above description is of one preferred embodiment of Applicants' invention. Other embodiments will be apparent to those of ordinary skills in the art, without departing from the scope of the invention. The invention is only limited by the attached claims.

We claim:

1. A method of providing location information for mobile telecommunications stations comprising the steps of:
taking a measurement of the present location of said mobile station and transmitting said location to an Emergency Bureau;
repeating said measurement after the lapse of an interval of time; and
taking additional measurements as needed to trace movements of said mobile station.

2. The method of claim 1, wherein said the steps of taking said measurements comprise the steps of taking said measurements using signals derived from a Global Positioning System.

3. The method of claim 1, wherein more frequent measurements are made if said mobile station is detected to be moving.

4. The method of claim 1, further comprising the steps of:
automatically initiating the taking of said measurements and reporting of said measurements if an automobile containing said mobile station is started without disabling a measurement and reporting system.

5. The method of claim 1, wherein an interval between successive measurements is decreased if two previous measurements were not equal.
